(19) United States
(12) Patent Application Publication
(10) Pub. No.: US 2011/0283611 A1
(43) Pub. Date: Nov. 24, 2011

(54) TRELLIS AND NETTING SUPPORT SYSTEM

(76) Inventor: Anthony Topping, White Plains, NY (US)

(21) Appl. No.: 12/784,064

(22) Filed: May 20, 2010

(51) Int. Cl. A01G 13/02

(52) U.S. Cl. 47/31

(57) ABSTRACT

A netting or trellis support for use with hollow-top stakes comprises a pole having a lower end sized to be received in the hollow top of a respective stake and to extend in a vertical direction. First and second sleeves have respective first and second attachment members. The first sleeve is affixed proximate the top end of the pole. The second sleeve is mounted for rotation relative to the first attachment member. The attachment members are supported by the pole so as to have a generally coincident axis that is perpendicular to the vertical direction. The netting or trellis is supported at least between the first and second attachment members. In a more particular arrangement, cross members can be engaged to an attachment member of each of two adjacent poles. The netting or trellis support can be used in conjunction with a raised border system.

### FIELD OF THE INVENTION

This invention relates to the home gardening and landscape industry, and, more particularly, to an accessory device adapted to add fencing or netting to a raised border or landscape edging system.

### BACKGROUND OF THE INVENTION

In the home gardening industry, edging systems can be employed to create a border between a garden feature and natural surroundings. A variety of garden features can be defined by an edging system including, without limitation, a flower bed, a vegetable garden, and a sandbox.

One versatile edging system known in the art is described in U.S. Pat. No. 6,202,367 of Marino et al., assigned to the present assignee. Marino et al. system includes support brackets that receive timber of arbitrary length and stakes of different shapes and sizes. The bracket has a beam receiving portion that receives and fastens to any standard size strip of lumber, including hollow, engineered lumber such as may be constructed as a composite of recycled plastic, wood fiber, rice hulls, resin, in various proportions from zero to a finite amount. The bracket also has a portion that secures it to the stake while permitting rotation about the stake, say, from 60° to 300°, all while remaining upon an equal horizontal plane and perpendicular to the vertical axis of the stake. The stakes of the Marino patent are constructed to permit further stakes to be vertically engaged on top and inside of a lower stake to enable a raised edging system of various heights to be constructed, with each course remaining upon an equal horizontal plane and perpendicular to the vertical axis of the stake.

Using a system such as described in the Marino patent, edging can be constructed of arbitrary shape and height. For example, the user can encircle a large area or create a variety of shapes such as a semi-circle, octagon, triangle, trapezoid or parallelogram, such as by choosing engineered lumber that has the desired shape and attaching the lumber using the brackets and securing the edging to the ground and previous courses using stakes. As a result, the user can be quite creative in defining a space using the edging system. Yet for many projects there is a need to extend the height of the system with netting or trellises rather than lumber, such as for a vegetable garden, flower bed or the like. In this way, the user can access the contained space or admire it while still having an animal or child barrier in place.

A difficulty results, however, when constructing the netting or trellis system upon an arbitrarily configured space. An improvement in the art, as provided by the disclosed invention, is a trellis and netting support system that is supported by, and thereby is adapted to, the contours of the edging system.

### SUMMARY OF THE INVENTION

According to one aspect of the invention, a netting or trellis support for use with hollow-top stakes comprises a pole having a lower end sized to be received in the hollow top of a respective stake and to extend in a vertical direction. First and second sleeves have respective first and second attachment members. The first sleeve is affixed proximate the top end of the pole. The second sleeve is mounted for rotation relative to the first attachment member. The attachment members are supported by the pole so as to have a generally coincident axis that is perpendicular to the vertical direction. The netting or trellis is supported at least between the first and second attachment members.

In a more particular, optional arrangement, cross members can be engaged to an attachment member of each of two adjacent poles.

The netting or trellis support can be used in conjunction with a raised border system. More particularly, the stakes used to seat the poles can be part of a raised border system that further comprises a beam-receiving support bracket that includes a mounting column having a through-channel which is sized and shaped to receive one of the stakes. The mounting column permits rotation of the support bracket thereabout. As such, the beams in the raised border system can be positioned at arbitrary angles about the stake, while the attachment members included on the poles can be used to rotate at least the second sleeve independent of any rotation of the support bracket about the stake.

Other aspects, features and advantages of the invention will be apparent in view of the accompanying description of certain embodiments thereof when considered in connection with the accompanying drawing figures.

### BRIEF DESCRIPTION OF THE DRAWINGS

FIG. 1 is a perspective view of a raised border system showing a netting and trellis support system according to one embodiment of the invention.

FIG. 2 is a perspective view of a stake and support bracket that can be used with the invention.

FIG. 3 is an exploded view of the stake and support brackets of FIG. 2.

FIG. 3A is an exploded view showing a vertical stacking of stakes and a portion of the netting and trellis support system according to one embodiment of the invention

FIG. 4 is a detailed view of attachment members of one embodiment of the invention.

FIG. 5 is a detailed view, partly in section, showing the attachment members according to another embodiment of the invention.

### DETAILED DESCRIPTION OF THE INVENTION

The invention is described in connection with a preferred mode in which it is used in conjunction with a raised border system in which a number of timbers are joined together by support brackets and secured in position by stakes, substantially as described in the aforementioned Marino et al. patent, U.S. Pat. No. 6,202,367, the disclosure of which is hereby incorporated by reference as if set forth in its entirety herein. It should be appreciated, however, that the present invention has advantages when used with stakes in applications that do not require a raised border or edging system.

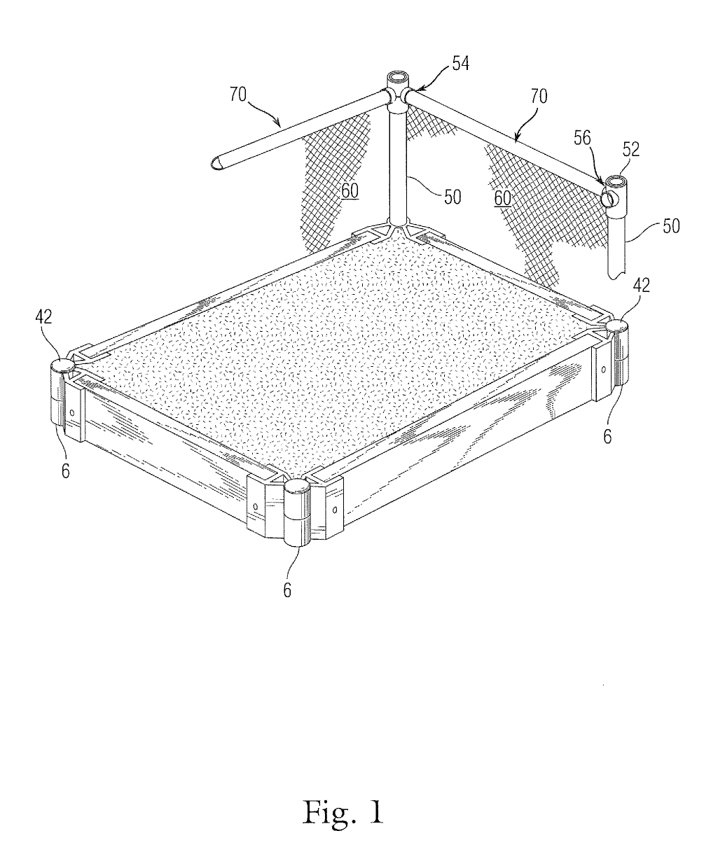

Referring briefly to FIGS. 1, 2 and 3, the basic construction of the support brackets 6 and stakes 21 are described. A support bracket 6 comprises a beam receiving portion 8, a spacer 9 and a mounting column 10. The mounting column 10 can have a generally circular cross section and defines a channel 11 having an inside surface 19 and outside surface 20. The beam receiving portion 8 is U-shaped and has a rear rim 12, a front rim 16 and a base 14, which define a channel for receiving beams of lumber. The mounting column extends along its outside surface 20 to the spacer 9, which, in turn, is fastened to the rear edge 15 of the base 14. When connected, the longitudinal axis of the channel 11 of the mounting column is parallel to the longitudinal axis of the channel defined by the beam receiving portion 8. It is desirable, but not mandatory, that the height of the mounting column 10 be one half of the height of the beam receiving portion 8. In a variation of the foregoing, the 9 spacer can be eliminated and the mounting column may be fastened directly to the rear edge of the base.

The stake 21 comprises a top support member 22, a body 24 and a tapered tip 26 for penetrating the ground. The top support member has an upper edge 30, a lower edge 28 and a hollow interior channel 31 defining an inside surface and an outside surface.

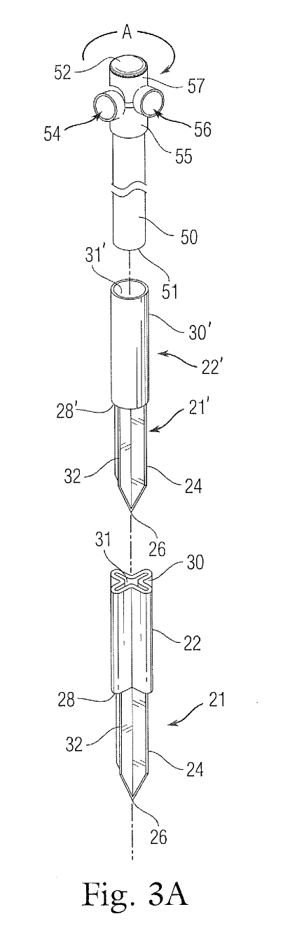

As illustrated in FIG. 3, the top support member of the stake is X-shaped, but this is not required. Any number of shapes may be used, such as a circle, as long as the stakes may still be vertically engaged in an effective manner so as to form a continuous top support member upon which the mounting column of the support bracket may effectively be secured. For instance, FIG. 3A illustrates stake 21′ having a circular cross-section for the interior channel 31′. The stake 21′ can have a tapered tip 26 and body as described above for receipt into the stake 21 or directly into the ground. Alternatively, a second stake 21′ can have its tapered tip 26 and body 24 received snugly within the top support member 22′, starting at an upper edge 30′ and extending downwardly to a lower edge 28′.

The support bracket and stake can be connected by inserting the top support member 22 of the stake into the channel 11 of the mounting column 10, so as to form a male/female connector, such that the top support member 22 acts as the male component and the mounting column 10 acts as the female component. Preferably, the outside surface of the top support member 22 is of such size so as to tightly engage the inside surface 19 of the mounting column 10. Two support brackets are used in conjunction with a single stake to secure one course of a raised border system. The brackets can rotate perpendicular to the vertical axis of the stake so as to permit different edging shapes to be defined created depending upon the needs and/or desires of the user.

See the aforementioned Marino et al. patent, U.S. Pat. No. 6,202,367 for further details of the support bracket 6 and stakes 21.

The hollow interior channel 31′ provides a receptacle for the netting or trellis support according to the present invention. In particular, and with further reference to FIG. 3A, a pole 50 is provided to extend the height of the raised border system or to provide a support above a stake 21 once placed in the ground. The pole has a lower end 51 which is sized and shaped to be received in the channel 31, 31′ of the stake 21, 21′. As illustrated, the pole 50 is tubular and this arrangement permits the lower end 51 to fit directly in the channel 31′. The pole 50, once seated in the stake, extends in a generally vertical direction away from the stake to a top end 52, as shown in FIG. 1. Also, when the pole is provided with a tubular end 51, it can rotate within the channel 31′ to provide adjustability of the orientation of the attachment members, described below.

As will be appreciated, the lower end 51 of the pole can include an adapter or other fitting to seat the pole 50 into the channel of the top section of the stake, regardless of the shape of the channel. Thus, for example, a fitting can be provided so as to impart an X-shaped termination at the lower end 51 that is received in the channel 31 of the stake 21 of FIG. 3.

Extending between the poles 50 can be a netting 60 or trellis (not shown). The netting or trellis can be secured to the poles or otherwise supported by attachment members 54, 56 that are mounted to each pole. Attachment members 54 and 56 are mounted to the pole proximate to the top end 52 of the pole and the netting or trellis can be extended generally from the height of the top of the stake 30 to the height of the attachment members and beyond. At least one of the attachment members is rotatable relative to the other so as to permit connection of netting, trellis, or cross-bars (discussed below) at arbitrary angles to suit the design chosen by the user for the border system.

In the illustrated embodiment, the attachment member 54 comprises a portion of a sleeve 55 that is affixed to the pole via a screw or the like. The sleeve 55 is disposed around the pole while the attachment member 54 is oriented perpendicularly to the vertical axis of the stake. The sleeve 55 can have a threaded hole for receiving the set screw, for example, while the pole can have a side hole that receives the set screw and prevents movement of the sleeve 55 relative to the pole 50.

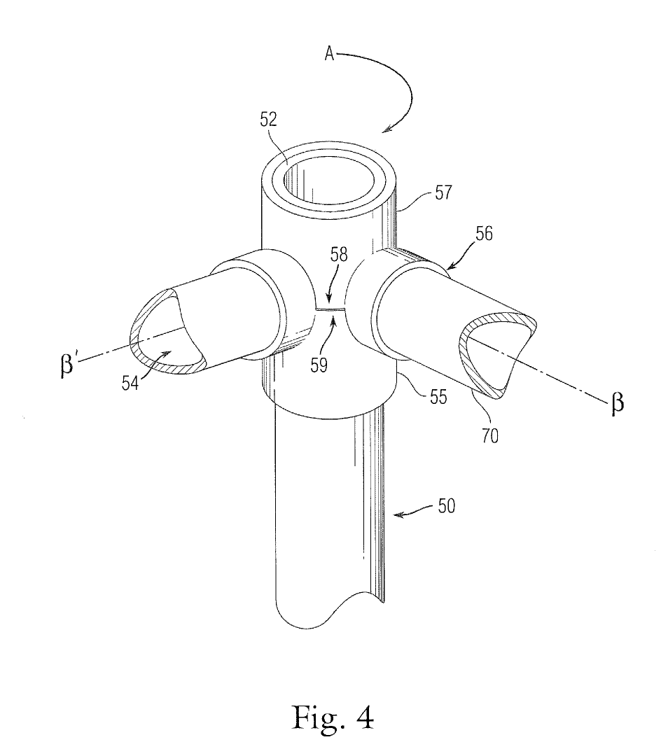

In the illustrated embodiment, the attachment member 56 comprises a portion of a sleeve 57 that is disposed on and around the pole 50, at about the top end 52, until a lower edge 58 abuts a top edge 59 of the sleeve 55 (see FIG. 4). The sleeve 57 is mounted for rotation relative to the first attachment member 54 and is in sliding abutting contact with the top edge 59. As such, the attachment member 56 can travel an arc of approximately 270° in the direction of arrow A. As will be understood, sleeve 55 can also be mounted for rotation, but in the illustrated embodiment the user has freedom to adjust the angle between the attachment members 54, 56 and their respective orientations by either moving sleeve 57 relative to the attachment member 54 (and sleeve 55), or by rotating the pole 50 within the stake 21′, or both.

Referring now to the detail view of FIG. 4, the sleeves 55, 57 are mounted on the pole so that the attachment members 54, 56 are aligned along a generally coincident axis B-B′. The axis B-B′ is perpendicular to the vertical direction of the stakes 21, 21′. By having the attachment members aligned along a common axis, cross members 70 can be attached and supported by the poles in a level manner relative to the top of the stakes and any associated raised border system. This is true even in applications in which a raised bed is arranged in a stairway fashion to define terraced spaces.

As shown in FIG. 1, each cross member 70 has an opposing end that has a size and shape that engages with both the first attachment member 54 of one pole 50 and the second attachment member 56 of another pole 50 at the same time. The cross members 70 can be provided as a set that is part of a kit with a corresponding set of poles and attachment members. Such a kit generally needs to have one less cross member than the number of poles. In other words, if there are M poles that come with a kit for mounting netting or trellis (M is an integer number), then there could be N cross members (N is also an integer numbers), where N is equal to one less than M. Because the cross members may have to be cut to size by the user, the cross members in a kit can include a prescribed number of feet of material that can be cut to size by the user.

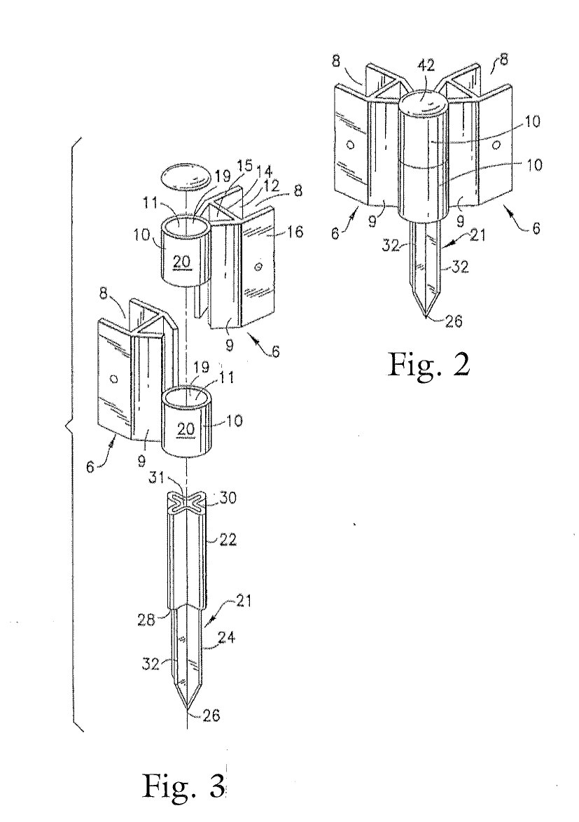

Optionally, an end cap 42 (FIGS. 1 and 2) can be secured to the upper end 30′,20′ of the stake 21, 21′ or to the top end 52 of the pole 50. The end cap can have an interference fit on its underside for easy fastening.

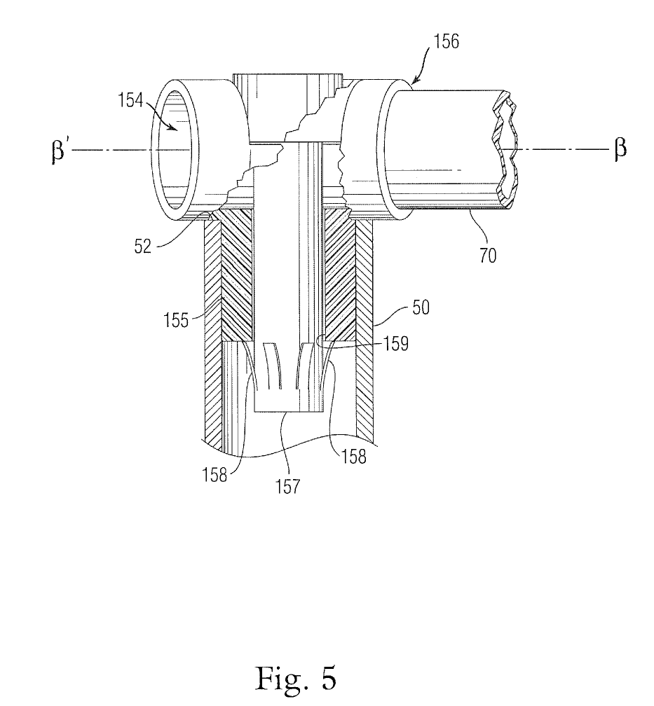

In a variation of the foregoing, as shown in FIG. 5, both of the sleeves are configured as having a first portion 155, 157 that is seated within the top end 52 of the pole 50 while the attachment members 154, 156 are aligned along a generally coincident axis B-B′. In another variation, one of the sleeves can be mounted outside of the pole 50 while the other is seated within the structure of the first sleeve. As illustrated in FIG. 5, however, each sleeve has a downwardly depending component. The portion 155 has an annular cross section that mates with the interior diameter of the pole 50, optionally in a close tolerance manner while permitting rotation of the portion 155. Alternatively, portion 155 can form an interference fit with the pole in an irrotatable manner to secure the attachment 154 to the pole. The portion 155 includes a central channel which is sized and shaped to receive a finger-portion 157. The finger can journal within the channel to permit relative rotation of the attachment 156. Optionally, the finger 157 can include a retention element 158 such as biased stops that permit insertion of the finger 157 into the channel 159, but which spring to an unbiased position (as shown) in which the finger 157 cannot be withdrawn from the channel 159.

As noted in the aforementioned U.S. Pat. No. 6,202,367, the inside diameter of each stake is of such size and shape that the body 24 and tapered tip 29 of one stake may be completely inserted into the hollow interior channel of another stake so as to vertically engage at least two stakes. When two stakes are vertically engaged, the lower edge 28, 28′ of the top support member of the insertion stake rests flush with the upper edge 30, 30′ of the top support member of the receiving stake below. In this way, a continuous top support member is created for securing at least one support bracket. Any number of stakes may be vertically engaged to create a continuous support member of any desired height.

In operation, one or more of the following steps may be practiced. The user sketches the design of the desired border to determine the number of stakes, support brackets and length of lumber needed to create the landscape edging that is desired. The user drives the stakes into the ground at the desired locations. Generally, the stakes are located at a corner of varying angle. The support brackets are secured to the stakes and rotated to the desired angles by placing the mounting columns 10 over the top support members of the stakes. Lengths of lumber including possibly engineered timbers from recycled materials, are cut to size such that the distal ends of each piece of lumber can be placed into the channel of the beam receiving portion of each support bracket. In this way, the raised border system anchors the lengths of lumber to the ground, thereby creating a bed or border system which may be filled with soil or the alike, depending on the needs of the user. The netting or trellis support poles are then vertically engaged into the top of the respective stakes, either before or after the sleeves and attachment members are positioned on the poles. An end cap can be placed on the top of the poles to keep out rain and dirt, or a lighting or watering component can be engaged to the top of the pole. As the poles are inserted into the stakes, cross members are positioned within the attachment members of adjacent poles and the assembly is then secured by the stakes and ready to receive netting or trellis on, about, in front of or behind the poles and cross members.

The invention is described in detail with reference to a particular embodiments thereof, but the scope of the invention is to be gauged by the claims that follow and also by those modifications that provide equivalent features to those that are claimed as such modifications are still within the spirit and scope of the invention.

1. A support for a netting or trellis for use with stakes having respective hollow top portions, comprising:
a pole having a lower end sized to be received in the hollow top portion of a respective stake, the pole extending in a generally vertical direction away from the stake to a top end;
a first sleeve affixed to the pole, proximate the top end thereof, the first sleeve having a first attachment member; and
a second sleeve mounted for rotation relative to the first attachment member and providing a second attachment member,
wherein the first and second attachment members are supported by the pole so as to have a generally coincident axis that is perpendicular to the vertical direction and wherein the second sleeve is rotatable relative to the first sleeve about the axis, and
wherein the netting or trellis is supported at least by the first and second attachment members.

2. The netting or trellis support as in claim 1, wherein the first sleeve is disposed around the pole.

3. The netting or trellis support as in claim 2, wherein the top end of the pole has a side hole and wherein the first sleeve is immovably affixed to the pole.

4. The netting or trellis support as in claim 1, wherein the first attachment member is rotatably affixed to the pole.

5. The netting or trellis support as in claim 1, wherein the pole is rotatable within the hollow top portion of the stake.

6. The netting or trellis support as in claim 1, wherein the second sleeve is disposed around the pole and has a portion that rotatably and slidably contacts the first sleeve.

7. The netting or trellis support as in claim 1, further comprising an end cap seated within or around or above the top end of the pole.

8. The netting or trellis support as in claim 1, wherein the second sleeve has a first portion seated within the top end of the pole and a second portion that includes the second attachment member.

9. The netting or trellis support as in claim 1, wherein the first and second sleeves each have a first portion seated within the top end of the pole and second portions that include respective first and second attachment members.

10. A netting or trellis support kit for use with stakes having respective hollow top portions, comprising:
a set of poles, wherein each pole has a lower end sized to be received in the hollow top portion of a respective stake and wherein each pole extends in a generally vertical direction away from the stake to a top end;
a first sleeve affixed to each pole, proximate the top end thereof, the first sleeve having a first attachment member;
a second sleeve mounted for rotation relative to each said first attachment member and providing a respective second attachment member; and
a set of cross members, each cross member having opposing ends that are sized and shaped to be engaged with one of the first attachment members of one pole in the set of poles and to be simultaneously engaged with one of the second attachment members of another pole in the set of poles,
wherein each first attachment member and each respective second attachment member is supported by a given pole in the set of poles so as to have a generally coincident axis that is perpendicular to the vertical direction and so as to have a respective second sleeve rotatable relative to the first sleeve about the axis, and
wherein the netting or trellis is supported at least by the first and second attachment members.

11. The netting or trellis support as in claim 10, wherein the set of poles includes M poles and the set of cross members includes N cross members, wherein M and N are integer numbers and N is equal to one less than M.

12. The netting or trellis support as in claim 10, wherein each first sleeve is disposed around one of the poles in the set of poles.

13. The netting or trellis support as in claim 12, wherein the top end of each pole has a side hole and wherein the first sleeve is immovably affixed to the pole.

14. The netting or trellis support as in claim 10, wherein the each attachment member is rotatably affixed to one pole in the set of poles.

15. The netting or trellis support as in claim 10, wherein each pole is rotatable within the hollow top portion of a respective stake.

16. The netting or trellis support as in claim 10, wherein the second sleeve is disposed around each pole and has a portion that slidably contacts the first sleeve.

17. The netting or trellis support as in claim 10, further comprising an end cap seated within or around or above the top end of each pole.

18. The netting or trellis support as in claim 10, wherein the second sleeve has a first portion seated within the top end of each pole and a second portion that includes the second attachment member.

19. The netting or trellis support as in claim 10, wherein the first and second sleeves each have a first portion seated within the top end of each pole and second portions that include respective first and second attachment members.

20. The netting or trellis support as in claim 10, wherein the stakes are part of a raised border system that further comprises a beam-receiving support bracket that includes a mounting column having a through-channel which is sized and shaped to receive one of the stakes and permit rotation of the support bracket thereabout, wherein the second sleeve is mounted for rotation independent of any rotation of the support bracket about the stake.
